(19) United States
(12) Patent Application Publication
(10) Pub. No.: US 2026/0162851 A1
(43) Pub. Date: Jun. 11, 2026

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: YU GONG, Huaian (CN); A-NAN YANG, Huaian (CN); HAN-RUN XIE, Huaian (CN); LU-YU CHANG, New Taipei (TW); YUH-TSENG CHEW, Rowland Heights, CA (US)

(21) Appl. No.: 18/973,665

(22) Filed: Dec. 9, 2024

(51) Int. Cl. H01B 11/10; H01B 11/00; H01B 11/08; H01B 11/20

(52) U.S. Cl. CPC H01B 11/1016; H01B 11/002; H01B 11/08; H01B 11/1091; H01B 11/203

(57) ABSTRACT

A cable includes: a core wire; a first shielding layer covering the core wire in a longitudinal manner; a second shielding layer covering the first shielding layer; and an outer sheath covering the second shielding layer, wherein the first shielding layer has at least two parts spaced apart to form adjacent portions, the second shielding layer has a plurality of parts covering the adjacent portions, and a width of each part of the second shielding layer is greater than a distance of the adjacent portions.

### BACKGROUND OF THE INVENTION

### Field of the Invention

The present invention relates generally to a cable, and more particularly to a cable used to transmit high frequency signals.

### Description of Related Arts

U.S. Patent Application Publication No. 2020/0098490 discloses a cable having an insulation layer with a seam and a shielding tape with a seam located oppositely.

U.S. Patent Application Publication No. 2021/0296026 discloses a cable comprising a pair of core wires, a first shielding layer covering the pair of core wires, and a second shielding layer covering the first shielding layer. The first shielding layer is a pure metal tape, the second shielding layer is AL/PET or Cu/PET. The first shielding layer and the second shielding layer are both covering the pair of core wires in a longitudinally wrapped manner, making the cable less resistant to bending. The second shielding layer is a metal foil tape including a PET layer and a metal layer so the PET layer is sandwiched between two metal surfaces.

Therefore, it is necessary to provide an improved cable with good shielding effect and easy to bend.

### SUMMARY OF THE INVENTION

A main object of the present invention is to provide a cable with good shielding effect and good bending resistance.

To achieve the above object, a cable comprises: a core wire; a first shielding layer covering the core wire in a longitudinal manner; a second shielding layer covering the first shielding layer; and an outer sheath covering the second shielding layer, wherein the first shielding layer has at least two parts spaced apart to form adjacent portions, the second shielding layer has a plurality of parts covering the adjacent portions, and a width of each part of the second shielding layer is greater than a distance of the adjacent portions.

Compared to prior art, in the present invention, the second shielding layer covers the adjacent portions of the first shielding layer so that when the cable is bent the second shielding layer can still cover and shield the adjacent part to have better bending resistance and better shielding effect.

### BRIEF DESCRIPTION OF THE DRAWING

FIG. 1 is a cross-sectional view of a first embodiment of cable of the present invention.

FIG. 2 is a cross-sectional view of a second embodiment of a cable of the present invention.

FIG. 3 is a cross-sectional view of a third embodiment of a cable of the present invention.

FIG. 4 is a cross-sectional view of a forth embodiment of a cable of the present invention.

FIG. 5 is a cross-sectional view of a fifth embodiment of a cable of the present invention.

FIG. 6 is a cross-sectional view of a sixth embodiment of a cable of the present invention.

FIG. 7 is a cross-sectional view of a seventh embodiment of a cable of the present invention.

### DETAILED DESCRIPTION OF THE PREFERRED EMBODIMENT

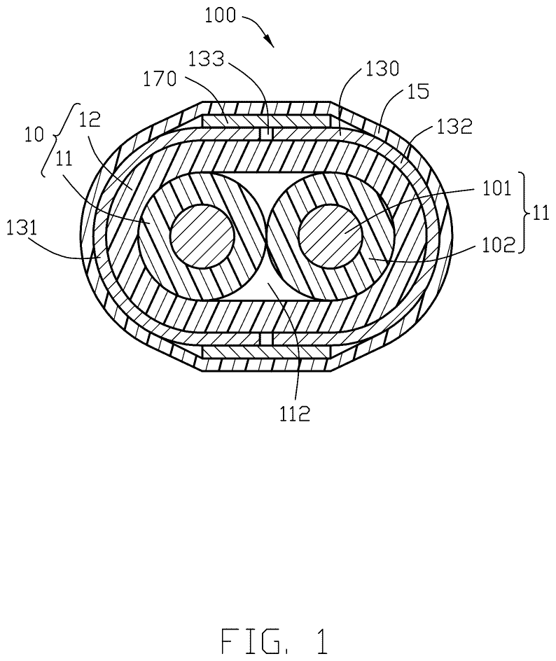

Referring to FIG. 1, a cable 100 of the present invention is shown. The cable 100 includes a core wire 10, a shielding layer 13 covering the core wire 10, and an outer layer 15 covering the shielding layer 13. The shielding layer 13 includes a first shielding layer 130 and a second shielding layer 170 arranged outside the first shielding layer 130.

The first shielding layer 130 longitudinally covers the core wire 10 and includes at least two parts and adjacent sides of two adjacent parts form adjacent portions. The adjacent portions of the first shielding layers do not overlap, but form openings 133 or seams or just touch. In this embodiment, the adjacent portions define an opening 133. Each of the openings 133 extends along a longitudinal direction. The number of the openings 133 of the first shielding layer 130 depends on the number of parts of the first shielding layer 130. The second shielding layer 170 covers the opening 133. Specifically, the second shielding layer 170 includes a plurality of parts, and the number of the parts of the second shielding layer 170 is the same as the number of openings. Each part of the second shielding layer 170 covers the corresponding opening 133 respectively. The second shielding layers 170 covering different openings 133 do not contact each other. The width of each part of the second shielding layer 170 is greater than the corresponding width of the opening 133, so that when the cable 100 is bent, the second shielding layer 170 can still cover and shield the openings 133, and the opening 133 does not slide out of the coverage of the corresponding part of the second shielding layer 170.

In this embodiment, the cable 100 is a twin-axial cable. The core wire 10 includes a pair of inner core wires 11 and an insulating sheath 12 covering the inner core wires 11. The pair of inner cores 11 are arranged in a transverse direction. The surfaces of the pair of inner cores 11 are in contact with each other and extend in parallel in the longitudinal direction. Each of the inner core wires 11 includes an inner conductor 101 and an inner insulating layer 102 covering the inner conductor 101 by extrusion molding. The inner conductor 101 is used to transmit high-speed signals. The cross-sectional shape of each inner core wire 11 is circular. The cross-sectional shape of the sheath 12 is semicircular on each side in the transverse direction. Air gaps 112 are formed on the upper and lower sides between the sheath 12 and the pair of inner core wires 11. The inner insulating layer 102 and the sheath 12 are made of solid material. The outer surface of the sheath 12 is smooth and flat.

In this embodiment, the first shielding layer 130 includes two parts, a first part 131 and a second part 132. The first part 131 and the second part 132 cover the core wire 10 symmetrically and longitudinally from the left and right sides respectively, leaving an upper opening 133 and a lower opening at the adjacent portions of the first part 131 and the second part 132. The upper and the lower openings 133 are respectively located in the middle of the upper side and the lower side in the transverse direction. The second shielding layer 170 is located between the first shielding layer 130 and the outer layer 15. The second shielding layer 170 includes a third part 171 covering the upper opening 133 and a fourth part 172 covering the lower opening 133. The size of the third part 171 and the fourth part 172 extending along the outer circumference of the cable 100 is larger than the size of corresponding the opening 133. The lateral sides of the third part 171 and the fourth part 172 can extend to the boundary of the semicircle. The third part 171 and the fourth part 172 are both arranged horizontally. The third part 171 and the fourth part 172 do not contact each other.

The first shielding layer 130 is made of metal mylar, which includes a base layer and a metal layer disposed on the base layer. The metal layer is arranged outward. The second shielding layer 170 is made of pure metal or alloy. Both the third part 171 and the fourth part 172 are in direct contact with the outer surfaces of the first part 131 and the second part 132. The second shielding layer 170 can be used for grounding. The material of the second shielding layer 170 can be a metal with good tin dipping properties to facilitate subsequent soldering of the cable 100. The outer layer 15 is made of hot sticky Mylar. The outer layer can be made of one or more layers.

In the present invention, the openings 133 are left on both upper and lower sides of the first shielding layer 130 of the cable 100, the third part 171 and the fourth part 172 of the second shielding layer 170 cover the upper and lower openings 133 respectively, the outer layer 15 covers and fixes the second shielding layer 170. The metal contact surfaces of the second shielding layer 170 and the first shielding layer 130 can slide relative to each other, so that the flexibility and bending resistance of the cable 100 are enhanced. The cable 100 of the present invention can be bent more than 90 degrees. The second shielding layer 170 is made of pure metal or alloy, which has better shielding performance. Compared with the traditional longitudinal covering structure of the shielding layer, there is an adhesive Mylar layer between the two metal surfaces in the overlapping part of the shielding layer. In the present invention, the metal surface of the first shielding layer 130 is in direct contact with the metal of the second shielding layer 170, and no non-metallic layer is sandwiched between the first shielding layer 130 and the second shielding layer 170, so that the first shielding layer 130 and the second shielding layer 170 jointly form a complete and tight metal shielding outside the sheath 12, which plays a vital role in controlling signal interference and noise. Compared with the traditional pure metal foil longitudinally wrapped structure, the bending resistance and oxidation resistance of the cable of the present invention are also effectively improved.

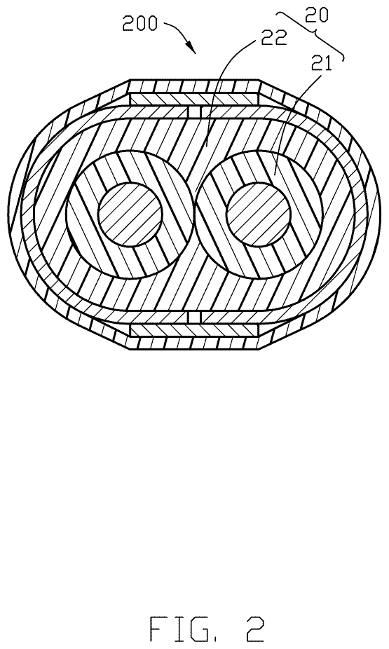

FIG. 2 shows the second embodiment of a cable 200 of the present invention. Compared with the first embodiment, in this embodiment, there is no air gap between the inner core wire 21 and the sheath 22.

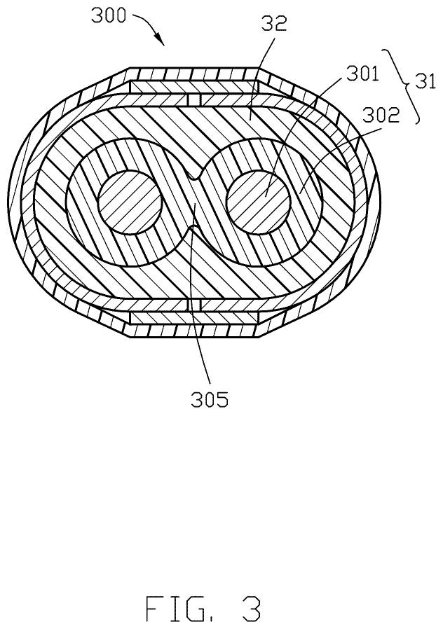

FIG. 3 shows the third embodiment of a cable 300 of the present invention. Compared with the second embodiment, in this embodiment, the inner insulating layer 302 of the inner core wire 31 is integrally extruded and molded outside the pair of inner conductors 301. The inner core wire 31 forms a horizontal 8 structure. The inner insulation layer 302 has an integral connection portion 305 between the pair of inner conductors 301. There is no air gap between the sheath 32 and the inner core wire 31.

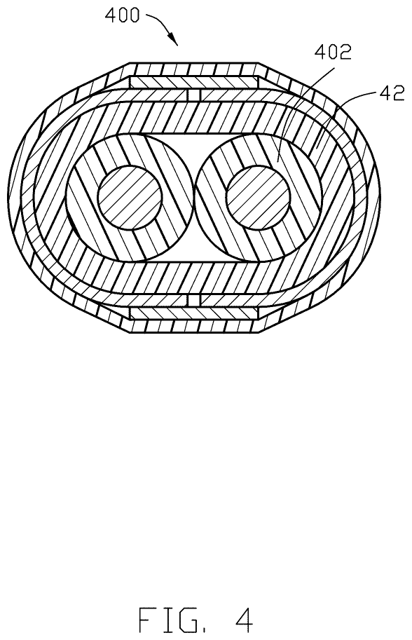

FIG. 4 shows the fourth embodiment of a cable 400 of the present invention. Compared with the first embodiment, in this embodiment, the inner insulating layer 402 is made of foam material, and the insulating sheath 42 is made of solid material.

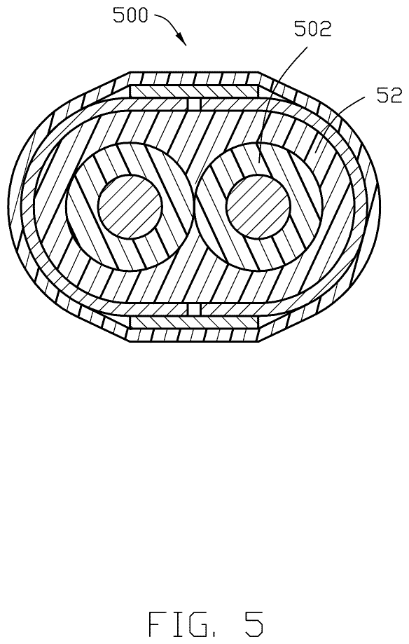

FIG. 5 shows the fifth embodiment of a cable 500 of the present invention. Compared with the second embodiment, in this embodiment, the inner insulating layer 502 is made of foam material, and the insulating sheath 52 is made of solid material.

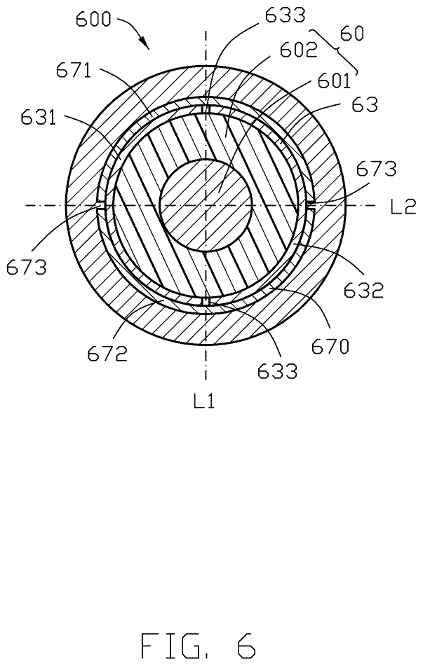

FIG. 6 shows the sixth embodiment of a cable 600 of the present invention. Compared with the first embodiment, in this embodiment, the cable 600 is a coaxial cable with only one inner conductor 601. The inner insulation layer 602 is extruded outside the inner conductor 601, and there is no sheath in this embodiment. The first part 631 and the second part 632 of the first shielding layer 630 of the shielding layer 63 are cover the circular core wire 60 from the left and right sides respectively, and leave openings 633 on the upper and lower sides. The third part 671 and the fourth part 672 of the second shielding layer 670 cover the first shielding layer 630 from the upper and lower sides, and leave openings 673 on the left and right sides. The second shielding layer 670 may extend to half of the circumference. A first connecting line L1 is formed between the two openings 633 of the first part 631 and the second part 632, and a second connecting line L2 is formed between the two openings 673 of the third part 371 and the fourth part 672. The first part 631 and the second part 632 are arranged axially symmetrically along the first connecting line L1, and the third part 671 and the fourth part 672 are arranged axially symmetrically along the second connecting line L2. The angle between the first connecting line L1 and the second connecting line L2 is 0-180 degrees. In this embodiment, the angle between the first connecting line L1 and the second connecting line L2 is 90 degrees. Both the first connecting line L1 and the second connecting line L2 pass through the center of the core wire 60. Compared with traditional coaxial cables in which the shielding layer is braided and wound, the cable 600 of this embodiment can effectively reduce crosstalk.

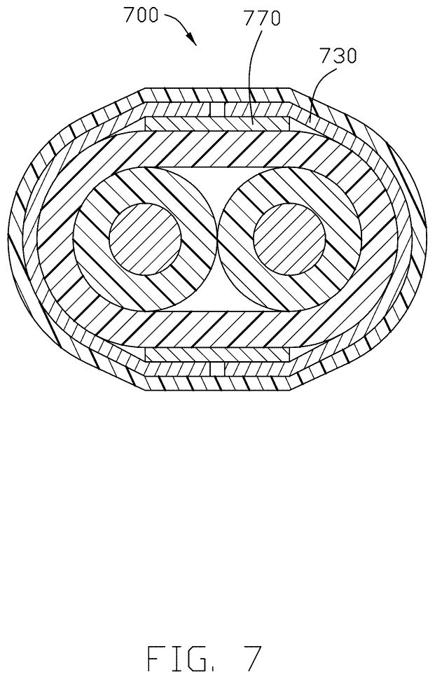

FIG. 7 shows the seventh embodiment of a cable 700 of the present invention. Compared with the first embodiment, in this embodiment, the second shielding layer 770 is disposed inside the first shielding layer 730, and the metal surface of the first shielding layer 730 faces inward toward the second shielding layer. In addition to the cable of the first embodiment, the cables of the second to sixth embodiments may also have the second shielding layer disposed inside the first shielding layer.

In the present invention, the first shielding layer 130 is longitudinally covers the core wire 10, and has a plurality of openings 133 on the first shielding layer 130. Each of the opening 133 extends along the longitudinal direction. The second shielding layer 170 made of pure metal covers each of the openings 133 so that the cable 100 has better bending resistance and shielding performance. The cable 100 of the present invention has high-speed signal transmission capability of 224 GHz and above.

1. A cable comprising:
a core wire;
a first shielding layer covering the core wire in a longitudinal manner;
a second shielding layer covering the first shielding layer; and
an outer sheath covering the second shielding layer; wherein
the first shielding layer has at least two parts spaced apart to form adjacent portions, the second shielding layer has a plurality of parts covering the adjacent portions, and a width of each part of the second shielding layer is greater than a distance of the adjacent portions.

2. The cable as claimed in claim 1, wherein the second shielding layer is made of pure metal or alloy material, the first shielding layer includes a base layer and a metal layer on the base layer, and the metal layer faces outward toward the second shielding layer.

3. The cable as claimed in claim 1, wherein the adjacent portions define openings or seams, and the parts of the second shielding layer do not contact each other.

4. The cable as claimed in claim 1, wherein the first shielding layer includes a first part and a second part, the second shielding layer includes a third part and a fourth part, the first part and the second part are arranged symmetrically along a first connecting line, and the third part and the fourth part are arranged symmetrically along a second connecting line perpendicular to the first connecting line.

5. The cable as claimed in claim 1, wherein the core wire is a coaxial wire or a twin-axial cable.
